(19) United States
(12) Patent Application Publication
(10) Pub. No.: US 2024/0067563 A1
(43) Pub. Date: Feb. 29, 2024

(54) APPARATUS AND PROCESS FOR PRODUCTION OF BURNT LIME OR DOLOMITE

(71) Applicant: Fels-Werke GmbH, Goslar (DE)

(72) Inventors: Tino REDEMANN, Wernigerode (DE); Gerrit DOMBROWSKI, Cramme (DE); Henning WEBER, Wolfenbüttel (DE)

(21) Appl. No.: 18/457,205

(22) Filed: Aug. 28, 2023

(30) Foreign Application Priority Data
Aug. 29, 2022 (EP) 22192633.0-1103

(51) Int. Cl. C04B 2/12; C04B 2/10

(52) U.S. Cl. CPC C04B 2/12; C04B 2/104

(57) ABSTRACT

An apparatus for production of burnt lime or dolomite has:
a shaft furnace having a preheating zone, a reaction zone, a separation zone and a cooling zone;
a first feed apparatus for CO₂ at the boundary of the separation zone to the reaction zone;
a first removal apparatus at the boundary of the cooling zone to the separation zone;
a second removal apparatus for CO₂ at the start of the preheating zone; and
at least one heating apparatus.

The shaft furnace also has a third removal apparatus for CO₂ above the reaction zone;
the third removal apparatus opens into the second removal apparatus outside the shaft furnace and upstream of the at least one heating apparatus;
the second removal apparatus opens into the at least one heating apparatus; and
the first feed apparatus is formed by the at least one heating apparatus for the shaft furnace.

The invention relates to an apparatus for production of burnt lime or dolomite, having
a shaft furnace having a preheating zone, a reaction zone, a separation zone and a cooling zone;
a first feed apparatus for CO₂ at the boundary of the separation zone to the reaction zone;
a first removal apparatus at the boundary of the cooling zone to the separation zone;
a second removal apparatus for CO₂ at the start of the preheating zone; and
at least one heating apparatus.

The apparatus is characterized in that
the shaft furnace also has a third removal apparatus for CO₂ above the reaction zone;
the third removal apparatus opens into the second removal apparatus outside the shaft furnace and upstream of the at least one heating apparatus;
the second removal apparatus opens into the at least one heating apparatus; and
the first feed apparatus is formed by the at least one heating apparatus for the shaft furnace.

The invention further relates to a process for producing burnt lime or dolomite, in which the deacidification reaction proceeds under a CO₂ atmosphere and the process energy needed is introduced via heated CO₂ which is circulated.

All of industry is facing the challenge of the energy transition and the switch to climatically neutral production. Specifically the lime industry is under particular pressure because of the process-related high CO₂ emissions that are released, for example, in the transformation of limestone to lime (1), or from calcite to calcium oxide.

CaCO₃→CaO+CO₂ (1)

In a conventional shaft furnace, the energy input to burn the lime or the dolomite is assured by a combustion process within the shaft furnace. In addition to the CO₂ which is released from the limestone as it is burnt, CO₂ emissions arise as a result of the combustion of a carbonaceous fuel in the shaft furnace. Depending on the type of furnace, this leads overall to a CO₂ concentration of around 20% to 40% in the offgases. For the purposes of environmental protection, it is desirable to reduce the release of CO₂ to the environment. Furthermore, the economic standpoint must not be neglected, since state pricing of the emission of CO₂ is taking place to an increasing degree. In all adjacent industries, developments are therefore being driven in this sector in order to minimize CO₂ emission in lime burning. There is therefore great industrial interest in novel processes for burning lime or dolomite that work with maximum CO₂ neutrality and are therefore very efficient and energy-saving. There is also an increase in customer desire for “green lime”. “Green lime” is used as a synonym for burnt lime produced in a climatically neutral manner.

The state of the art in this connection is, for example, conventional shaft furnaces with downstream CO₂ separation. The most technically mature technique for separation of the CO₂ from the offgases is amine scrubbing, by way of example. However, the amines have to be produced in an additional chemical plant downstream of the shaft furnace, which means extensive economic expenditure and personnel demands. The alternative utilization of fixed bed reactors or calcium looping methods is already known, but has not yet been tried or implemented on an industrial scale. In general, all methods have a very high energy requirement in order to concentrate the CO₂ in the offgases from a shaft furnace.

There are also known methods in which the combustion process in the shaft furnace is conducted with pure oxygen rather than air [DE 10 2013 010 909 B3, Maerz EcoKiln]. In these processes, a portion of the CO₂ formed in lime burning is fed back to the shaft furnace together with the oxygen. However, the operation of such a shaft furnace is costly because of the requirement for oxygen. A process in which CO₂ and oxygen are introduced into a shaft furnace as well as a fuel is likewise disclosed by JP 2009/161391 A.

Burnt lime is required in numerous industrial applications, including in the steel industry. There is a known process for provision of burnt lime in the steel industry that uses CO₂ as heat carrier medium in a shaft furnace [Yang et al.]. The shaft furnace in this process is divided into a preheating zone, a reaction zone, a separation zone and a cooling zone. The combustion process and hence the energy input in the process are not within the shaft furnace but outside it. All the CO₂ present in the shaft furnace is removed at a temperature of about 700° C. above the preheating zone and directed into a regenerator system. In the regenerator system, the CO₂ is heated to the required process temperature and then introduced into the shaft furnace at the boundary of the separation zone to the reaction zone.

A regenerator is in principle a heat transferer through which gas at a higher temperature and gas at a lower temperature flow alternately. As the gas at high temperature flows through the regenerator, the heat is stored intermediately in a storage medium (regenerator charging). Subsequently, the storage medium releases the heat to the gas at the lower temperature when it flows through the regenerator (regenerator discharging). The regenerator is generally charged and discharged in countercurrent. The gas for charging the regenerator flows through it from the top of the regenerator in the direction of the bottom of the regenerator, and the gas for discharging the regenerator flows through it in the exact opposite direction, from the bottom of the regenerator in the direction of the top of the regenerator.

The process gas utilized in the prior art processes is lean gas, but this is not necessarily available as process gas in the lime industry. High-energy fuels are used in the lime industry, such as natural gas or brown coal dust. The lean gas is directed through a preheater and heated, but this cannot be applied to the high-energy fuels in the lime industry. The process described by Yang et al. therefore cannot be used without great difficulty in the lime industry; it would at least be necessary to additionally provide a lean gas as fuel. It would be much more advantageous to have an available process and apparatus for burning of lime or dolomite that can be employed directly in the lime industry without needing to provide the additional fuels.

US 2020/0048146 A1 discloses a system similar to that described by Yang et al., with the disadvantages already described.

In the processes known from the prior art, in addition, the CO₂ flowing within the shaft furnace is drawn off at the top of the furnace. The heat capacity flow ratio Ω, which is defined by the heat capacity flows of two streams of matter in a heat transferer as

Ω=m₁·c₁/(m₂·c₂), (2)

where m is the mass flow rate and c the specific heat capacity, is found to be extremely unfavourable in the preheating zone. In the preheating zone, the heat capacity flow of the limestone is much lower than the heat capacity flow of the CO₂, and so the result is that the CO₂ is drawn off from the shaft furnace at a relatively high temperature of about 700° C. This high temperature leads to a correspondingly high loss of heat in the removal of the excess CO₂ from the overall process. This lowers the energy efficiency of the process. The heat capacity flow ratio of CO₂ to limestone in the processes known from the prior art is typically in the range from 2.5 to 4 [Yang et al.].

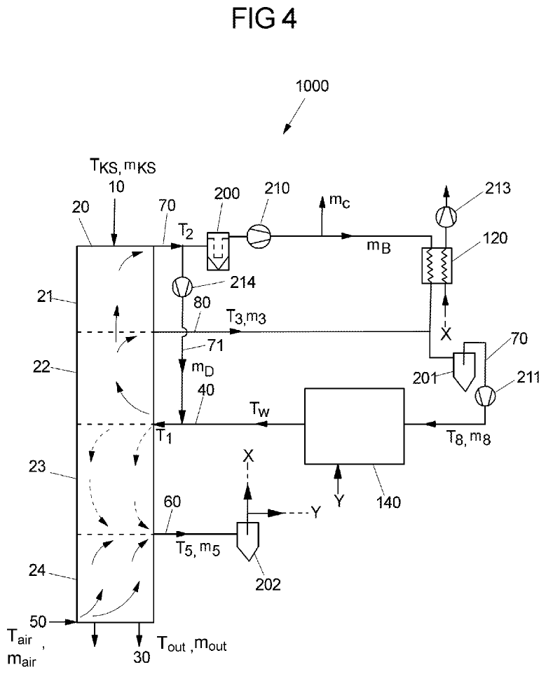

In addition, DE 10 2021 201 549 A1 discloses an apparatus for burning and/or calcining material in lumps. The offgas is removed at the top of the furnace and at least a substream of the offgas is heated and recycled into the furnace in order to heat the atmosphere in the combustion zone ([0010], [0012]). The heating of the substream(s) of the offgas may take place, for example, in a heat exchanger. The heat transfer fluid utilized in the heat exchanger may, for example, be offgas which is discharged from the cooling zone and/or the combustion zone [0017]. FIG. 4 of DE 10 2021 201 549 A1 is an embodiment in which a substream of the offgas is heated in the offgas outlet conduit 39 in the heat exchanger 35a, and a further substream of the offgas in the offgas outlet conduit 39 in the heat exchanger 35b. Subsequently, the two substreams are combined, heated further by the heater 54, and then introduced into the combustion zone of the furnace. In this apparatus, two heat exchangers and one heating apparatus are needed to heat the offgas which is drawn off at the top of the furnace to the necessary process temperature. Each component of the apparatus incurs maintenance and repair costs that reduce the economic viability of the apparatus.

Proceeding from the prior art, it is therefore an object of the invention to provide an apparatus with which the energy efficiency of a shaft furnace is increased in the burning of lime or dolomite, remedying the disadvantages known from the prior art. Furthermore, the CO₂ that emanates from the deacidification of the limestone is to be separated out in highly concentrated form, and it is to be possible to send this to further uses or suitable deposits.

For this purpose, the invention provides an apparatus according to claim 1 and a process according to claim 7.

### DETAILED DESCRIPTION

The features described hereinafter are applicable equally to the apparatus according to the invention and to the process according to the invention.

The invention provides an apparatus for production of burnt lime or dolomite. The apparatus comprises a shaft furnace and at least one heating apparatus. The shaft furnace has a preheating zone, a reaction zone, a separation zone and a cooling zone. At the start of the preheating zone, the carbonate-containing rock, referred to as limestone hereinafter, is introduced into the shaft furnace at a temperature T_{KS} and a mass flow rate mics. Carbonate-containing rock in the context of the invention means untreated rock in the form of limestone or dolomite rock. Dolomite rock CaMg[CO₃]₂ is also known as dolomite spar, rhombic spar or pearl spar. All the descriptions hereinafter relating to limestone are equally applicable to dolomite rock, unless indicated otherwise. This is also applicable in particular to the specification of mass flow rates and temperatures. The deacidified carbonate-containing rock which is obtained after the burning operation is referred to as lime, burnt lime or quicklime in the case of limestone as starting material, or as burnt dolomite or dolomite in the case of dolomite rock as starting material. All the descriptions hereinafter relating to lime and burnt lime or quicklime are equally applicable to burnt dolomite or dolomite, unless indicated otherwise.

Typically, the temperature of the limestone T_{KS} corresponds to the ambient temperature. The mass flow rate mics of the limestone is typically in the range from 1.65 to 1.85 kg/kgₗᵢₘₑ or kg/kg_{dolomite}, but may also be in the range above 1.85 kg/kg in the case of very high MgCO₃ contents in the starting rock or below 1.65 kg/kg in the case of a low carbonate content (MgCO₃ or CaCO₃ content) in the starting rock or high proportions of unburnt material in the lime end product. The limestone is heated in the preheating zone by the CO₂ flowing within the shaft furnace. CO₂ in the context of the invention means a gas mixture having a CO₂ concentration exceeding 75%, preferably exceeding 85%, more preferably exceeding 95%. In the preheating zone, the limestone is heated up to the required deacidification temperature which, in the case of a virtually pure CO₂ atmosphere, depending on the untreated rock, is in the region of 900° C. No deacidification reaction takes place yet in the preheating zone. An exception is dolomite rock, having a MgCO₃ content which is already deacidified at low temperatures.

The preheating zone is followed by the reaction zone, in which the limestone is supplied with further heat and deacidified. Virtually the entire deacidification reaction of the limestone takes place in the reaction zone, such that burnt lime is already present at the end of the reaction zone. Temperatures in the reaction zone are above 900° C.

The reaction zone is followed by the separation zone. At the boundary of the separation zone to the reaction zone is disposed a first feed apparatus which introduces CO₂ heated to process temperature T₁ into the shaft furnace at a mass flow rate m₁. The CO₂ with temperature T₁ provides the necessary energy input to enable a deacidification reaction of the limestone in the shaft furnace. There is thus advantageously no need for a combustion process within the shaft furnace.

Temperature T₁ is in the range of 950 and 1500° C., preferably in the range of 1000 and 1400° C., more preferably in the range of 1050 and 1350° C. Mass flow rate m₁ is greater than 4 kg/kgₗᵢₘₑ.

The separation zone is followed by the cooling zone. At the end of the cooling zone, cooling air for cooling of the lime at a temperature Tₐᵢᵣ and a mass flow rate mₐᵢᵣ is introduced into the shaft furnace by a second feed apparatus. The cooling air flows around and cools the burnt lime. Temperature Tₐᵢᵣ is in the region of ambient temperature. The mass flow rate of cooling air main is at least 0.7 kg/kgₗᵢₘₑ.

According to the invention, the shaft furnace has a first removal apparatus between the cooling zone and the separation zone. This removal apparatus removes the heated cooling air at temperature T₅ from the shaft furnace at mass flow rate m₅. The first removal apparatus thus separates the cooling zone in accordance with the invention from the separation zone. The cooling zone chosen should be sufficiently large that it is possible to ensure sufficient cooling of the burnt lime. This is a measure customary in the art and is therefore already known from the prior art. Temperature T₅ is in the range of 100 and 1200° C., preferably in the range of 500 and 1000° C., more preferably in the range of 600 and 900° C. Mass flow rate m₅ is ideally equal to mass flow rate m₅>mₐᵢᵣ. If cooling air is drawn in the direction of the reaction zone and sucked in with the CO₂ at the top of the furnace, m₅<mₐᵢᵣ. If, by contrast, a portion of the CO₂ from the reaction zone gets into the region of the cooling air suction and is sucked away together with the cooling air, m₅>mₐᵢᵣ. The top of the shaft furnace is the portion where the shaft furnace is charged with the limestone.

The separation zone serves for physical separation of the CO₂ atmosphere in the reaction zone and preheating zone, and of the air atmosphere in the cooling zone. At the end of the cooling zone is an apparatus for discharging the burnt lime. As a result, the cooled burnt lime is discharged from the shaft furnace at temperature Tₒᵤₜ and with mass flow rate mₒᵤₜ. Apparatuses for discharge are known to the person skilled in the art and are, for example, sliding stages by which the burnt lime is discharged from the shaft furnace. Temperature Tₒᵤₜ is typically in the range from 20 to at most 200° C.

According to the invention, the shaft furnace also has a second removal apparatus for CO₂ above the preheating zone at the top of the furnace, and a third removal apparatus for CO₂ above the reaction zone. The third removal apparatus may therefore be disposed in accordance with the invention at the transition of the preheating zone to the reaction zone, or else upstream of the transition to the reaction zone in a region of the preheating zone. In a preferred embodiment of the invention, the third removal apparatus for CO₂ is disposed at the boundary of the reaction zone to the preheating zone. As already described, CO₂ in the context of the invention includes a gas mixture having a CO₂ concentration exceeding 75%, preferably exceeding 85%, more preferably exceeding 95%.

In a further preferred embodiment of the invention, the third removal apparatus is disposed above the reaction zone in such a way that the temperature T₃ of the CO₂ removed via the third removal apparatus is in the range of 400 and 1000° C., preferably in the range of 600 and 1000° C., more preferably in the range of 800 and 900° C.

In a further embodiment of the present invention, the positions of the removal and feed apparatuses fix the zones of the shaft furnace. The preheating zone extends between the second removal apparatus and the third removal apparatus, the reaction zone extends between the third removal apparatus and the first feed apparatus, the separation zone extends between the first feed apparatus and the first removal apparatus, and the cooling zone extends between the first removal apparatus and the second feed apparatus.

By virtue of this configuration, it is possible to remove a portion A of the CO₂ from the shaft furnace with a temperature T₃ and a mass flow rate m₃ above the reaction zone via the third removal apparatus. The removal of CO₂ via the third removal apparatus reduces the mass flow rate of CO₂ in the preheating zone of the shaft furnace.

Temperature T₃ is in the range of 400 and 1000° C., preferably in the range of 600 and 1000° C., more preferably in the range of 800 and 900° C. Mass flow rate m₃, in a preferred embodiment of the present invention, should be chosen such that the CO₂ remaining in the furnace results in a capacity flow ratio of CO₂ to limestone in the preheating zone in the range from 1 to 2, preferably in the range from 1 to 1.6, more preferably in the range from 1 to 1.2.

The CO₂ remaining in the furnace can be removed from the shaft furnace with a temperature T₂ and mass flow rate m₂ at the start of the preheating zone via the second removal apparatus.

A portion B of the CO₂ removed via the second removal apparatus can be conducted onward in the removal apparatus with a mass flow rate m_{B}, while a portion C with temperature T₂ and a mass flow rate m_{C} is removed from the process.

Temperature T₂ is in the range of 80 and 700° C., preferably in the range of 80 and 400° C., more preferably in the range of 80 and 250° C. The mass flow rate m₂ above 1.7 kg/kgₗᵢₘₑ, preferably in the range from 1.7 to 3.4 kg/kgₗᵢₘₑ, more preferably in the range from 1.7 to 2.1 kg/kgₗᵢₘₑ.

Mass flow rate m_{B} is in the range above 1 kg/kgₗᵢₘₑ, preferably in the range from 1 to 1.9 kg/kgₗᵢₘₑ, more preferably in the range from 1 to 1.4 kg/kgₗᵢₘₑ.

Mass flow rate m_{C} is equal to the mass flow rate of CO₂ that emanates from the limestone on deacidification and is in the order of magnitude of 0.75 kg/kgₗᵢₘₑ, preferably in the range from 0.7 to 0.85 kg/kgₗᵢₘₑ.

The reduced heat capacity flow ratio in the preheating zone by comparison with the prior art processes means that the exit temperature T₂ of the CO₂ at the top of the furnace is much lower, which reduces the loss of heat via the CO₂ to be discharged (mc) and hence increases the energy efficiency of the shaft furnace system.

According to the invention, the third removal apparatus opens into the second removal apparatus. Once the CO₂ from the third removal apparatus has been introduced into the second removal apparatus, the CO₂ flows onward into the at least one heating apparatus with temperature T₈ and mass flow rate m₈.

Temperature T₈ is in the range from 500 to 1000° C., preferably in the range from 600 to 900° C., more preferably in the range from 650 to 900° C. Mass flow rate m₈ is equal to m₁.

The present invention also has at least one heating apparatus. According to the invention, the third removal apparatus opens into the second removal apparatus outside the shaft furnace and before the second removal apparatus opens into the at least one heating apparatus. According to the invention, the first removal apparatus of the shaft furnace is again formed by the at least one heating apparatus for the shaft furnace, meaning that it connects the at least one heating apparatus to the shaft furnace. The CO₂ removed via the second and third removal apparatuses is thus directed in accordance with the invention at least partly into the at least one heating apparatus. The CO₂ is heated therein to temperature T_{W} and fed to the shaft furnace via the first feed apparatus.

In particular, the CO₂ removed by the third removal apparatus, before it is combined with the CO₂ removed via the second removal apparatus, in accordance with the invention, does not pass through any heat exchanger and hence does not also serve as heat transfer fluid in such a heat exchanger. In a particularly preferred execution, the third removal apparatus opens into the second removal apparatus outside the shaft furnace and upstream of the at least one heating apparatus, with no heat exchanger in the third removal apparatus.

In a particularly preferred embodiment, the invention has exactly one heating apparatus, such that the third removal apparatus opens into the second removal apparatus outside the shaft furnace and upstream of the one heating apparatus. The CO₂ removed via the second and third removal apparatuses is preferably combined and, in accordance with the invention, directed at least partly into the exactly one heating apparatus.

The CO₂ is thus at least partly circulated in the present invention. The CO₂ which is not circulated, as already described, is removed from the process. An emission of diluted CO₂ from the shaft furnace into the atmosphere can thus advantageously be avoided. The CO₂ removed is available for further applications. Environmental pollution is correspondingly reduced, and an economic cost saving is achieved by the reduction in CO₂ levies.

According to the invention, the CO₂ removed via the second and third removal apparatuses is combined and heated by at least one heating apparatus, preferably by exactly one heating apparatus, and fed back to the shaft furnace. In the present invention, the CO₂ removed via the second and third removal apparatuses thus circulates within the shaft furnace.

The prior art discloses processes (DE 10 2021 201 549 A1) in which offgas is removed from the combustion zone. This is then used as heat transfer fluid in a heat exchanger for heating of the offgas which is drawn off at the top of the furnace. In this way, it is possible to heat the offgas which is drawn off at the top of the furnace to a temperature of 300° C. to 600° C. However, the process temperature required in the combustion zone is temperatures between 800° C. and 1500° C. It is therefore necessary to supply further heat to the offgas already heated in the heat exchanger by means of a heating apparatus and/or another heat exchanger, in order to obtain the necessary process temperatures.

In the present invention, the CO₂ removed from the shaft furnace via the third removal apparatus is not used to heat the offgas removed at the top of the furnace in a heat exchanger; instead, the two CO₂ streams are combined without an intervening heat exchanger. As a result, the CO₂ that flows into the heating apparatus has a temperature T₈ in the range from 500 to 1000° C. The already significantly higher temperature of the CO₂ before it enters the heating apparatus by comparison with the processes from the prior art means that less energy has to be supplied via the at least one heating apparatus in order to heat the offgas to the necessary process temperature before introduction into the shaft furnace. The process according to the invention is thus more efficient and economic.

According to the invention, the temperature T_{W} at the exit from the at least one heating apparatus is equal to the inlet temperature T₁ of the CO₂ into the shaft furnace.

According to the invention, the at least one heating apparatus is a regenerator system, an electrical heating system or a combination of these. In one embodiment, the invention has exactly one heating apparatus; in this embodiment, the exactly one heating apparatus is a regenerator system, an electrical heating system or a combination of these. In one embodiment, exclusively an electrical heating system is used. This has the advantage that the combustion process needed for the input of heat within a regenerator system is absent. This eliminates the offgases that result from the combustion process.

In a further embodiment, a combination of an electrical heating system and a regenerator system is used, which preferably has at least two regenerators. At least two regenerators are needed in order that it is possible to switch between them during the charging and discharging operations, and hence a continuous process regime can be assured. In this case, the CO₂ is first heated by the regenerator system and then directed into the electrical heating system in which the CO₂ is supplied with further heat. This embodiment has the advantage that the regenerators used in the regenerator system do not have to be heated to the process temperature needed for the burning of the lime or dolomite. It is thus also possible to use storage materials in the regenerators that are suitable for temperatures below the process temperature in the shaft furnace. The process temperature for the burning of the lime or dolomite or the process temperature in the shaft furnace in this case describes the temperature that the CO₂ must have when fed into the shaft furnace via the first removal apparatus to introduce sufficient energy into the shaft furnace to allow the burning of the lime or dolomite to be performed.

If the at least one heating apparatus comprises a regenerator system, the regenerator system preferably has at least two regenerators, a first preheater, a feed for fresh air, and a feed for a fuel. The regenerator system may alternatively have more than two regenerators, for example three.

In this embodiment, fresh air at a temperature T_{F} and a mass flow rate m_{F} is heated to a temperature T_{FV} in the first preheater and utilized as combustion air for combustion with a fuel. According to the invention, the fuel is selected from carbonaceous fuels and/or hydrogen. In a preferred embodiment, the fuel is a gaseous fuel. The use of a gaseous fuel has the advantage that input of ash into the regenerator on charging is avoided.

In one embodiment of the present invention, the combustion of the fuel takes place at the top of the regenerator. In a further embodiment of the invention, the combustion of the fuel takes place in a combustion chamber upstream of the top of the regenerator.

The fuel used for the combustion is more preferably a fuel selected from the group comprising natural gas, biogas, hydrogen and gasified solid fuels, for example wood gas. The combustion gases formed in the combustion at a temperature T₇ are directed through the regenerator in order to heat the storage material in the regenerator to temperature T_{RK} at the top of the regenerator or T_{RF} at the bottom of the regenerator, and hence to charge it. After they have passed through the regenerator, the combustion gases are led off as offgases. The offgases are at a temperature T_{off}. The temperature T_{off} is in the range from 500 to 1200° C., preferably in the range from 650 to 1100° C., more preferably in the range from 800 to 1000° C. Advantageously, the offgases are directed through the first preheater in order to heat the fresh air to temperature T_{FV} therein. It is thus possible to preheat the fresh air in an energy-efficient manner by means of the residual heat in the offgases.

It is possible via the supply of the fresh air with mass flow rate m_{F} as combustion air to control the mass flow rate of the combustion gas that results from the combustion of the fresh air with the fuel. Preferably, the mass flow rate of the combustion gases that flows through the regenerator system is controlled in such a way that this is about the same as the mass flow rate m₈ of the CO₂ that flows through the regenerator system on discharging. In this way, it is possible to control the heat capacity flow ratio between combustion gas that flows through the regenerator system on charging and CO₂ that flows through the regenerator system on discharging. Preferably, the average heat capacity flow ratio of combustion gas and CO₂ in the regenerator system is between 0.7 and 1.3, preferably between 0.9 and 1.1; more preferably, the average heat capacity flow ratio is 1. The effect of this is that the regenerator in the regenerator system is more uniformly charged, and the temperature difference after charging between the top and bottom of the regenerator is smaller than in the processes utilized from the prior art. The storage material of the regenerator in the regenerator system can therefore be utilized more effectively. The effect of this is advantageously that the temperature difference between the temperature T_{RK} of the storage material at the top of the regenerator and the temperature T_{W} of the CO₂ on leaving the regenerator at the top is much smaller than in the processes known from the prior art. Advantageously, this significantly reduces the thermal stresses that occur in the regenerator material, especially at the top of the regenerator. The stress on the regenerator material is reduced, and the lifetime or maintenance interval thereof is increased compared to the regenerators known from the prior art (cf. Yang et al.).

Temperature T_{F} is in the region of ambient temperature. Mass flow rate m_{F} depends to a crucial degree on the mass flow rate of CO₂ which is directed through the regenerator system during discharging and is greater than 2.6 kg/kgₗᵢₘₑ.

Temperature T_{FV} is in the range from 100 to 1000° C., preferably in the range from 500 to 1000° C., more preferably in the range from 700 to 900° C.

In a further embodiment of the present invention, the first removal apparatus is connected to the regenerator system. In this case, the fresh air heated to temperature T_{FV} in the preheater may additionally be supplied with at least a portion of the cooling air removed by the first removal apparatus at temperature T₅. In one embodiment, all the cooling air drawn off at temperature T₅ is supplied to the fresh air heated in the first preheater. The gas mixture then serves as combustion air in the combustion of the fuel, where the fuel is selected from carbonaceous fuels and/or hydrogen, especially selected from the group comprising natural gas, biogas, hydrogen and gasified solid fuels, for example wood gas. The combustion gases formed in the combustion at a temperature T₇ are directed through a regenerator and heat it to temperature T_{RK} at the top of the regenerator or T_{RF} at the bottom of the regenerator and hence charge the regenerator. The offgases leaving the regenerator may, as already described, be utilized for heating of the fresh air in the first preheater.

Natural gas in the context of the invention is understood to mean either L gas (low-calorific gas) or H gas (high-calorific gas). Biogas describes a high-energy gas mixture formed in the natural breakdown of organic material with exclusion of air. Wood gas is a gas which is obtained by the gasification of wood.

Regardless of whether fresh air or a gas mixture of fresh air and the cooling air removed from the shaft furnace by the first removal apparatus serves for the combustion, the use of the abovementioned fuels results in attainment of a temperature T₇ of the combustion gas which is at a somewhat higher temperature than the CO₂ at the exit from the regenerator system (Tw) and between 1000 and 1600° C., preferably between 1100 and 1500° C., more preferably between 1150 and 1450° C. The storage material in the at least one regenerator is heated in accordance with the invention to temperature T_{RK} at the top of the regenerator and T_{RF} at the bottom of the regenerator.

Temperature T_{RK} is between T_{W} and T₇. Temperature T_{RF} is at a somewhat higher temperature level than the CO₂ at the inlet into the regenerator system (T₈).

In one embodiment of the present invention, the second removal apparatus is connected directly to the first feed apparatus via a shortcut conduit upstream of the point at which the third removal apparatus opens into it. This makes it possible to mix a portion D with the mass flow rate m_{D} of the CO₂ drawn off via the second removal apparatus at temperature T₂ with the CO₂ which is introduced into the shaft furnace via the first feed apparatus. This makes it possible to control the temperature T₁ independently of the at least one heating apparatus used. If it is not possible by means of the at least one heating apparatus used to guarantee a constant temperature of the CO₂ on departure from the first heating system, especially the at least one heating apparatus, this can advantageously be compensated for by control of the mass flow rate m_{D} which is fed in via the shortcut conduit.

Mass flow rate m_{D} is much lower than m₁, and is in the region of less than 1 kg/kgₗᵢₘₑ.

In a further embodiment of the present invention, the first removal apparatus is in contact with the second removal apparatus in the form of a second preheater. The second preheater is preferably positioned such that the second removal apparatus passes through the preheater before the third removal apparatus opens into the second removal apparatus. This embodiment makes it possible for the heated cooling air at temperature T₅ removed via the first removal apparatus to be directed at least partly into the preheater, where it is utilized to heat a portion of the CO₂ removed via the second removal apparatus. The CO₂ that flows through the second preheater is heated from temperature T₂ to temperature T_{2V}. The preheater makes it possible for heat to be transferred between the two gas streams that flow past one another.

This embodiment enables a further saving of energy since the heat from the cooling air removed via the first removal apparatus can be utilized for heating of the circulated CO₂. Furthermore, there is the advantage that in-process heat can be recovered from the heated cooling air without this cooling air being directed into the regenerator system as combustion air and leading to unwanted introduction of dust.

Temperature T_{2V} is greater than T₂ via the heat recovery and is in the range of 200 and 1000° C., preferably in the range of 400 and 900° C., more preferably in the range of 500 and 800° C.

Removal apparatus in the context of the present invention is understood to mean an apparatus having at least one means of removing a gas and at least one conduit for passing the gas removed onward. Means of removing gases are, for example, suction apparatuses such as fans, especially hot gas fans. The mass flow rate of the gas which is drawn off is preferably controllable.

Feed apparatus in the context of the present invention is understood to mean an apparatus having at least one means of introducing a gas into a vessel, especially into a shaft furnace. The feed apparatus accordingly also comprises at least one conduit for passing the gas onward. The mass flow rate of the gas which is introduced is preferably controllable.

The conduits of the feed apparatuses and/or removal apparatuses, in a preferred embodiment, also have filters, fans and valves. In a preferred embodiment, the removal apparatuses in particular have filters for dedusting the CO₂ removed. Filters refer here generally to apparatuses for dedusting gases. These may be, for example, fabric filters or else hot gas cyclones. Valves may be used for control, stoppage, division and/or redirection of the mass flows. Blowers are used to create the gas flow in the conduits.

In order to monitor the process parameters of the combustion operation, the apparatus may have a temperature sensor and/or a pressure sensor at at least one point. The apparatus preferably has temperature sensors and/or pressure sensors at various suitable points. These may be positioned, for example, in the conduits of the feed apparatuses and or in the conduits of the removal apparatuses. The apparatus preferably has temperature sensors and/or pressure sensors at the points needed to enable control and/or monitoring of the apparatus according to the invention.

In one embodiment, the apparatus may accordingly comprise a controller with which the process parameters (temperature, pressure, mass flow rates) can be monitored and controlled.

All the features of the invention that have been described can be combined with one another in accordance with the invention.

The invention further provides a process for producing burnt lime or dolomite in an apparatus having
a shaft furnace having a preheating zone, a reaction zone, a separation zone and a cooling zone;
a first feed apparatus at the boundary of the separation zone to the reaction zone;
a first removal apparatus at the boundary of the cooling zone to the separation zone;
a second removal apparatus for CO₂ at the start of the preheating zone;
at least one heating apparatus;
a third removal apparatus for CO₂ above the reaction zone; wherein the third removal apparatus opens into the second removal apparatus outside the shaft furnace and upstream of the at least one heating apparatus;
the second removal apparatus opens into the at least one heating apparatus; and
the first feed apparatus is formed by the at least one heating apparatus for the shaft furnace.

The process is characterized in that
a) limestone or dolomite rock is introduced into the preheating zone of the shaft furnace;
b) preheated CO2 at a temperature T1 and with a mass flow rate m₁ is introduced into the shaft furnace via the first feed apparatus between separation zone and reaction zone;
c) a portion A of the CO2 with mass flow rate m₃ and temperature T3 is removed from the shaft furnace via the third removal apparatus above the reaction zone;
d) the remaining CO2 with temperature T2 is removed from the shaft furnace via the second removal apparatus at the start of the preheating zone, a portion B of the CO2 removed is passed onward with mass flow rate mB, and a portion C is sent to other uses or suitable deposits with mass flow rate mC;
e) portion A of the CO2 is combined with portion B of the CO2 to give a mixed gas with temperature T8, and the mixed gas with temperature T8 is heated to temperature TW in the at least one heating apparatus, and the CO2 with temperature TW forms at least a portion of the preheated CO2 which is fed to the shaft furnace in process step b) via the first feed apparatus;
f) the burnt lime or dolomite is cooled in the cooling zone by cooling air supplied, and the cooling air with temperature T5 and mass flow rate m₅ is removed again from the shaft furnace via the first removal apparatus between the cooling zone and the separation zone; and
g) the cooled burnt lime or dolomite is discharged from the shaft furnace with temperature Tout and mass flow rate mout.

All the features and advantages set out for the apparatus according to the invention are also applicable to the process according to the invention and vice versa.

In a preferred embodiment, the invention provides a process for producing burnt lime or dolomite in an apparatus having
a shaft furnace having a preheating zone, a reaction zone, a separation zone and a cooling zone;
a first feed apparatus at the boundary of the separation zone to the reaction zone;
a first removal apparatus at the boundary of the cooling zone to the separation zone;
a second removal apparatus for CO₂ at the start of the preheating zone;
a heating apparatus;
a third removal apparatus for CO₂ above the reaction zone; wherein
the third removal apparatus opens into the second removal apparatus outside the shaft furnace and upstream of the one heating apparatus;
the second removal apparatus opens into the one heating apparatus; and
the first feed apparatus is formed by the one heating apparatus for the shaft furnace.

The process is characterized in that
a) limestone or dolomite rock is introduced into the preheating zone of the shaft furnace;
b) preheated CO2 at a temperature T1 and with a mass flow rate m₁ is introduced into the shaft furnace via the first feed apparatus between separation zone and reaction zone;
c) a portion A of the CO2 with mass flow rate m₃ and temperature T3 is removed from the shaft furnace via the third removal apparatus above the reaction zone;
d) the remaining CO2 with temperature T2 is removed from the shaft furnace via the second removal apparatus at the start of the preheating zone, a portion B of the CO2 removed is passed onward with mass flow rate mB, and a portion C is sent to other uses or suitable deposits with mass flow rate mC;
e) portion A of the CO2 is combined with portion B of the CO2 to give a mixed gas with temperature T8, and the mixed gas with temperature T8 is heated to temperature TW in the one heating apparatus, and the CO2 with temperature TW forms at least a portion of the preheated CO2 which is fed to the shaft furnace in process step b) via the first feed apparatus;
f) the burnt lime or dolomite is cooled in the cooling zone by cooling air supplied, and the cooling air with temperature T5 and mass flow rate m₅ is removed again from the shaft furnace via the first removal apparatus between the cooling zone and the separation zone; and
g) the cooled burnt lime or dolomite is discharged from the shaft furnace with temperature Tout and mass flow rate mout.

In a preferred embodiment, the process is executed in the apparatus according to the invention.

In the process according to the invention, limestone or dolomite rock at temperature T_{KS} is introduced into the preheating zone of the shaft furnace at a mass flow rate mics. In addition, CO₂ is introduced into the shaft furnace via the first feed apparatus at a temperature T₁ with a mass flow rate m₁ at the boundary of the separation zone to the reaction zone. The limestone or dolomite is heated by the CO₂ in the preheating zone and reaches a temperature in the reaction zone which is sufficient to start the deacidification reaction.

A portion A of the CO₂ in the shaft furnace is removed from the shaft furnace via the third removal apparatus at a temperature T₃ with a mass flow rate m₃ between reaction zone and preheating zone. The rest of the CO₂ in the shaft furnace is removed from the shaft furnace at the start of the preheating zone at a temperature T₂ and a mass flow rate m₂. A portion B of the CO₂ removed is passed onward with mass flow rate m_{B}, and a portion C is drawn off from the process as highly concentrated CO₂ with a mass flow rate m_{C} and can be sent to further uses or suitable deposits.

Portion A of the CO₂ is combined with portion B of the CO₂, and the mixed gas at temperature T₈ is directed into a heating apparatus, where it is heated to temperature Tw. In one embodiment of the present invention, the CO₂ that leaves the heating apparatus at temperature T_{W} is the CO₂ which is fed to the shaft furnace at mass flow rate m₁ in process step b). In this temperature, temperature T₁ is equal to temperature T_{W}.

Portion A and portion B of the CO₂ removed from the shaft furnace are introduced back into the shaft furnace and hence form a circuit. The deacidification reaction (equation 1) in the shaft furnace releases additional CO₂ on burning of the lime or dolomite. This excess CO₂ which is not required for the circulation in the process for burning lime or dolomite is removed from the process as portion C, sent to a further use, or compressed and stored in suitable deposits. The shaft furnace itself can therefore advantageously be operated by the process according to the invention in such a way that the CO₂ that occurs in the deacidification from the limestone or dolomite is separated out in highly concentrated form and is not released into the environment diluted with combustion gases.

The burnt lime or dolomite is cooled in the cooling zone by supplied cooling air, and the heated cooling air at temperature T₅ and mass flow rate m₅ is removed from the shaft furnace via the first removal apparatus between the cooling zone and the separation zone. According to the invention, the cooling air is introduced into the shaft furnace at a temperature Tₐᵢᵣ and a mass flow rate mₐᵢᵣ.

The cooled burnt lime or dolomite is discharged from the shaft furnace at the end of the cooling zone at temperature Tₒᵤₜ and with mass flow rate mₒᵤₜ.

The removal of portion A of CO₂ at the boundary of the reaction zone to the preheating zone reduces the mass flow of CO₂ in the preheating zone. The heat capacity flow ratio of CO₂ to limestone in the preheating zone is thus favourably influenced. As a consequence, according to the invention, the temperature T₂ with which the remaining CO₂ is drawn off at the start of the preheating zone, i.e. at the top of the shaft furnace, lowers, which leads to a saving of energy in the overall process. The heat capacity flow ratio of CO₂ to limestone or dolomite is in the range from 1 to 2, preferably in the range from 1 to 1.6, more preferably in the range from 1 to 1.2.

Preferably, the removal by suction of portion A of the CO₂ removes between 30% and 90%, preferably between 40% and 85%, more preferably between 55% and 75%, of the overall gaseous CO₂ above the reaction zone. The mass flow m₃ to be removed by suction can be controlled, for example, by the exit temperature of the CO₂ at the top of the furnace.

The temperature T₂ of the CO₂ removed by suction at the start of the preheating zone is within a range of 80 and 700° C., preferably in the range of 80 and 400° C., more preferably in the range of 80 and 250° C. By virtue of the correspondingly low temperature, it is advantageously sufficient to design CO₂ fans and CO₂ filters for this lower temperature range.

In principle, the removal of the CO₂ and of the cooling air by suction from the shaft furnace is effected by means of suitable fans. Especially in the case of removal of the CO₂ by suction at the top of the furnace, a CO₂ filter that filters unwanted dusts is connected downstream of the suction. The filter is designed for the corresponding temperatures of the CO₂. If the cooling air removed from the shaft furnace by suction is used further, for example in a heating apparatus or a preheater, it passes through a suitable filter or hot gas cyclone after being removed from the shaft furnace by suction and hence freed of dusts.

In one embodiment of the present process, the process further comprises the step that
h) a portion D of the CO₂ removed in process step d) is fed into the CO₂ preheated to temperature T_{W} via a shortcut conduit before it is introduced into the shaft furnace.

In this embodiment, portion D at a mass flow rate m_{D} and temperature T₂ is mixed with the CO₂ with temperature T_{W} from the heating apparatus and introduced into the shaft furnace. This makes it possible to compensate for fluctuations in temperature because of the heating of m₁ in the heating apparatus via mixing with mass flow m_{D}. The advantages of this embodiment have already been described in connection with the apparatus according to the invention.

In a further embodiment of the present process, prior to process step e), portion B of the CO₂ removed in process step d) is heated to temperature T_{2V} in a preheater by a portion of the cooling air removed in process step f).

As a result of the removal of portion A of the CO₂ from the shaft furnace, as described, the temperature T₂ of portion B of the CO₂ removed is within a range of 80 and 700° C., preferably in the range of 80 and 400° C., more preferably in the range of 80 and 250° C., and hence below the temperature T₅ with which the heated cooling air is removed from the shaft furnace. In this embodiment, this is utilized to heat portion B of the CO₂ removed by means of a preheater before this is supplied with portion A. For this purpose, both a portion of the cooling air removed and portion B of the CO₂ are directed through a preheater in which the heat transfer takes place. The mass flow rate mx of the cooling air which is directed into the preheater is in the range from 0% to 100%, preferably in the range from 60% to 100%, more preferably in the range from 80% to 100%. In one embodiment of the process, the entirety of the cooling air removed from the shaft furnace is directed through the preheater.

In one embodiment of the present invention, the at least one heating apparatus in process step e) comprises at least two regenerators, one preheater, one fresh air feed and one fuel feed, and the process is further characterized in that
fresh air is heated to a temperature T_{FV} in the preheater;
the fresh air heated to temperature T_{FV} serves for combustion with a fuel selected from carbonaceous fuels and/or hydrogen; and
the combustion gases formed in the combustion are guided through at least one regenerator at a temperature T₇ and heat the regenerator to temperature T_{RK} at the top of the regenerator and T_{RF} at the bottom of the regenerator.

In one preferred embodiment of the present invention, the one heating apparatus in process step e) comprises at least two regenerators, one preheater, one fresh air feed and one fuel feed, and the process is further characterized in that
fresh air is heated to a temperature T_{FV} in the preheater;
the fresh air heated to temperature T_{FV} serves for combustion with a fuel selected from carbonaceous fuels and/or hydrogen; and
the combustion gases formed in the combustion are guided through at least one regenerator at a temperature T₇ and heat the regenerator to temperature T_{RK} at the top of the regenerator and T_{RF} at the bottom of the regenerator.

In a further embodiment of the present invention, the at least one heating apparatus in process step e) comprises at least two regenerators, one preheater, one fresh air feed and one fuel feed, and the process is further characterized in that
fresh air is heated to a temperature T_{FV} in the preheater;
the fresh air heated to temperature T_{FV} in the preheater is additionally supplied with a portion of the cooling air removed in process step f), and the gas mixture serves for combustion of a fuel selected from carbonaceous fuels and/or hydrogen; and
the combustion gases formed in the combustion are guided through at least one regenerator at a temperature T₇ and heat the regenerator to temperature T_{RK} at the top of the regenerator and T_{RF} at the bottom of the regenerator.

In a further preferred embodiment of the present invention, the one heating apparatus in process step e) comprises at least two regenerators, one preheater, one fresh air feed and one fuel feed, and the process is further characterized in that
fresh air is heated to a temperature T_{FV} in the preheater;
the fresh air heated to temperature T_{FV} in the preheater is additionally supplied with a portion of the cooling air removed in process step f), and the gas mixture serves for combustion of a fuel selected from carbonaceous fuels and/or hydrogen; and
the combustion gases formed in the combustion are guided through at least one regenerator at a temperature T₇ and heat the regenerator to temperature T_{RK} at the top of the regenerator and T_{RF} at the bottom of the regenerator.

In one embodiment of the process, all the cooling air removed from the shaft furnace in process step f) is fed into the fresh air heated in the preheater.

The embodiments having a regenerator system have the advantage that it is possible to choose flexibly between different fuels. Preference is given to using fuels selected from carbonaceous fuels and/or hydrogen, especially selected from the group comprising natural gas, biogas, hydrogen and gasified fuels, such as wood gas. It is therefore possible to utilize either fossil fuels such as natural gas or fuels that enable a CO₂-neutral combustion process. Fuels that enable a CO₂-neutral combustion process are, for example, biogas, hydrogen and gasified solid fuels, such as wood gas. In the shaft furnace, all CO₂ formed and introduced is removed by suction and either conducted onward in a circuit or removed from the process and sent to another use and/or compressed and stored in suitable deposits. When a regenerator with a CO₂-neutral combustion process is used, there is likewise no emission of CO₂ which is of relevance for the calculation of a CO₂ levy. This embodiment of the process according to the invention thus creates a way of producing burnt lime in a CO₂-neutral manner from limestone in a shaft furnace. CO₂-neutral production is likewise possible when the heating apparatus in process step e) is an electrical heating system. The same of course also applies to the combination of at least two regenerators and one electrical heating system.

Even when fossil fuels are used, it is possible to greatly reduce emission of CO₂ compared to the processes known from the prior art.

Furthermore, the temperature progression in the regenerator is much more favourable since the difference in temperature at the top of the regenerator on charging with CO₂ and combustion gas at a heat capacity flow ratio of about one is much smaller than in the case of regenerator systems as utilized in the prior art. The present process can exploit the storage area of the regenerator over the entire area and hence much more effectively.

The process according to the invention additionally makes it possible to influence the reactivity of the burnt lime or dolomite produced in various ways. Reactivity describes the reactiveness of the burnt lime or dolomite. This is dependent primarily on the combustion temperature, combustion time and chemical composition of the raw limestone. A homogeneous combustion temperature in particular results in a higher reactivity [Schiele/Berens].

In one embodiment of the process of the invention, the combustion temperature in the shaft furnace is
(i) controlled by controlling temperature T1 while mass flow rate m₁ is constant or
(ii) the combustion temperature in the shaft furnace is controlled by controlling the mass flow rate m₁ while temperature T1 is constant.

In both embodiments, the temperature T₂ with which the CO₂ is removed from the shaft furnace at the start of the preheating zone can be kept constant by controlling the amount of CO₂ which is drawn off from the shaft furnace at the boundary of the reaction zone to the preheating zone.

In a further embodiment of the present invention, the reactivity of the burnt lime or dolomite is controlled by controlling the mass flow rate mₒᵤₜ. It is possible in this way to adjust the dwell time of the lime or dolomite in the shaft furnace. This is possible since the dwell time of the lime or dolomite in the shaft furnace is advantageously independent of the energy input into the shaft furnace and of the amount of cooling air introduced into the shaft furnace. For example, it is possible, in the case of a constant lime throughput or dolomite throughput (mass flow rate mₒᵤₜ), to increase the amount of circulating CO₂ (mass flow rate m₁) and/or the temperature thereof (temperature T₁) such that the average CO₂ temperature in the reaction zone falls and the lime dwells at higher temperature. This forces the sintering process and decreases reactivity. This is not assured by processes according to the prior art. There is a dependence here between lime throughput or dolomite throughput in the furnace, i.e. the dwell time of the lime or dolomite in the furnace, the amount of fuel and the amount of combustion air.

The process and the apparatus that are provided by the present invention offer numerous advantages of the prior art.

The apparatus, by virtue of the configuration of the third removal apparatus, makes it possible to favourably influence the heat capacity flow ratio of limestone to CO₂ in the region of the preheating zone above the third removal apparatus, and hence to reduce the heat loss via the removal of CO₂ via the first removal apparatus at the top of the furnace at a lower temperature by comparison with the processes known from the prior art.

The invention provides an inexpensive process and an apparatus for burning of lime or dolomite with integrated separation of the CO₂ formed in the deacidification of the limestone or dolomite rock, with simultaneous flexibility of energy supply. The flexibility of energy supply results from the flexible use of the at least one heating apparatus in the form of a regenerator system, of an electrical heating system, or of a combination of these. In this way, it is possible to use energy on the basis of fossil or renewable fuels. It is likewise possible to combine this with electrical energy and to supply heat exclusively via an electrical heating system.

The process and the apparatus thus have all the prerequisites for CO₂-neutral lime production. The excess CO₂ in this case is sent to a further use and/or compressed and stored in suitable deposits.

This reduces the dependence of the production costs on state CO₂ levies and simultaneously increases the production volume of “green lime”.

The process of the invention additionally offers the option of influencing the reactivity of the burnt lime or dolomite produced.

The process of the invention and the apparatus of the invention enable an increase in the quality of the burnt lime or dolomite produced. Since the combustion process takes place outside the shaft furnace in the case of the use of a regenerator system, the burnt lime or dolomite in the shaft furnace does not come into direct contact with the combustion process itself, or with the fossil or renewable energy carriers used and the ashes thereof. The use of an electrical heating system also prevents a combustion process within the shaft furnace.

The apparatus according to the invention and the process according to the invention, by comparison with the processes and apparatuses known from the prior art, are more energy-efficient, entail lower apparatus complexity, and are thus more economically viable.

Furthermore, the apparatus according to the invention and the process according to the invention are usable in the lime industry since it is possible to use high-energy fuels compared to the prior art, and hence to utilize existing infrastructure in the lime works.

The present invention is elucidated in detail hereinafter by 11 figures with one comparative example and 2 working examples.

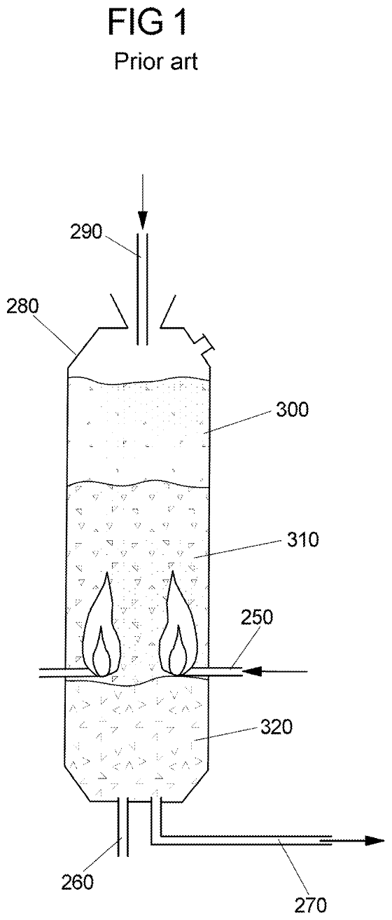

FIG. 1 shows a shaft furnace for burning of lime from the prior art;

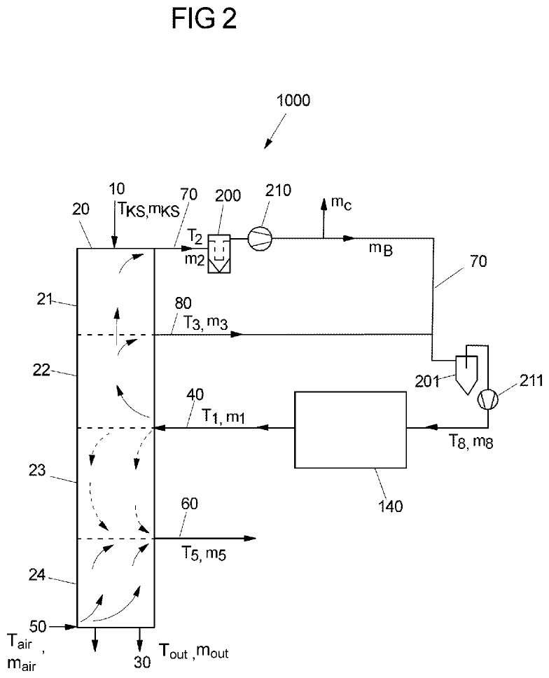

FIG. 2 shows one embodiment of the present invention;

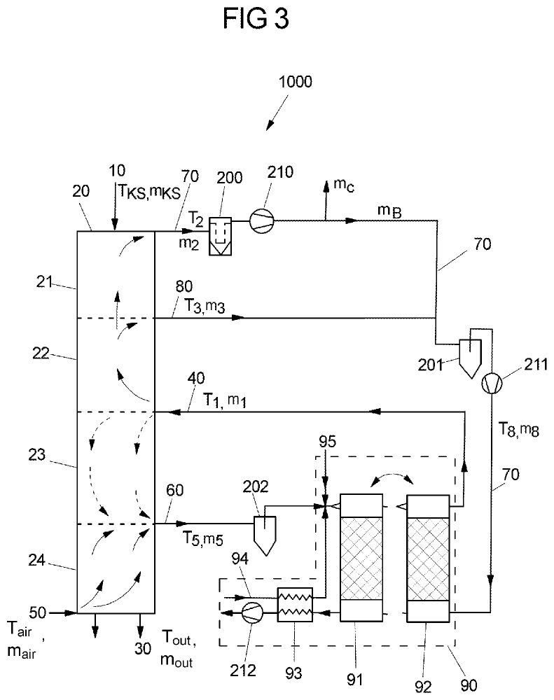

FIG. 3 shows a further embodiment of the present invention;

FIG. 4 shows a further embodiment of the present invention;

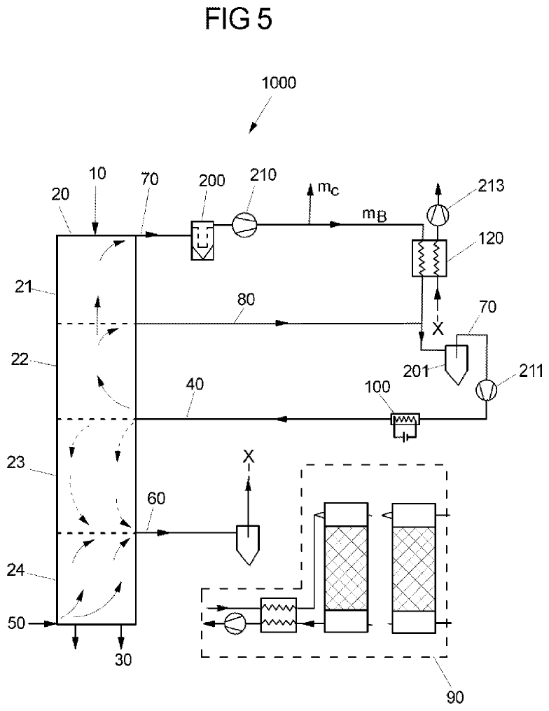

FIG. 5 shows a further embodiment of the present invention;

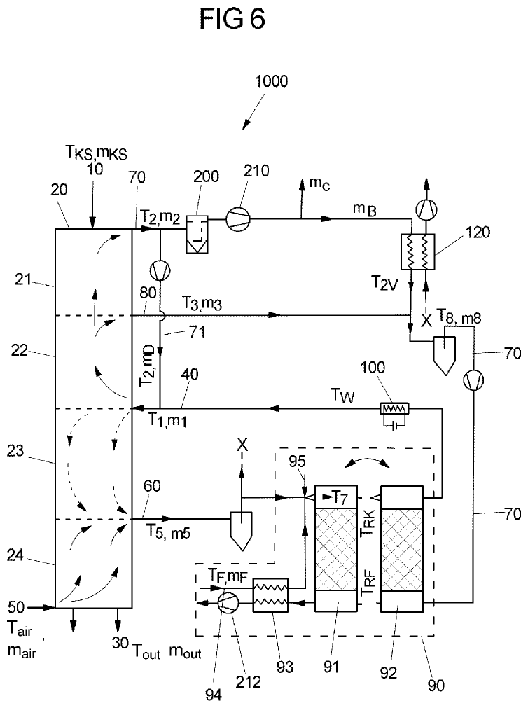

FIG. 6 shows a further embodiment of the present invention;

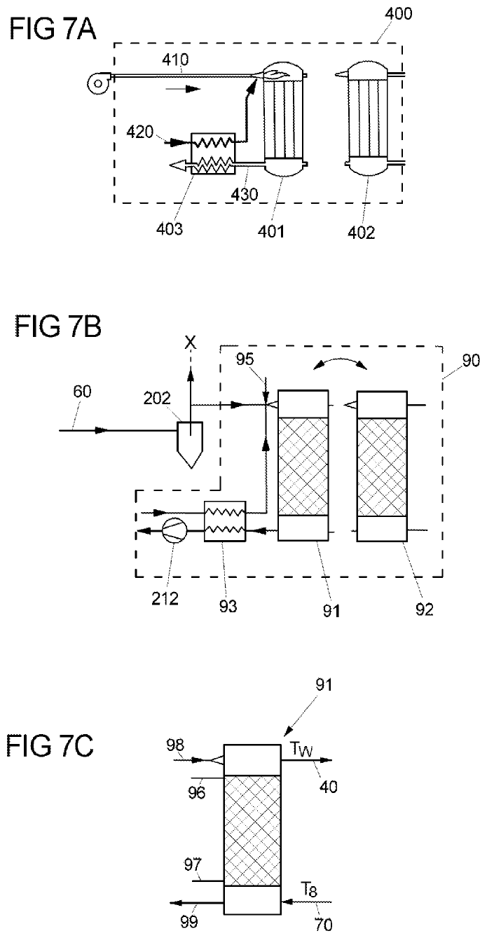

FIG. 7 (A) shows a regenerator system which is operated by a process from the prior art; (B) shows a regenerator system which is operated by the present process; (C) shows a regenerator of a regenerator system;

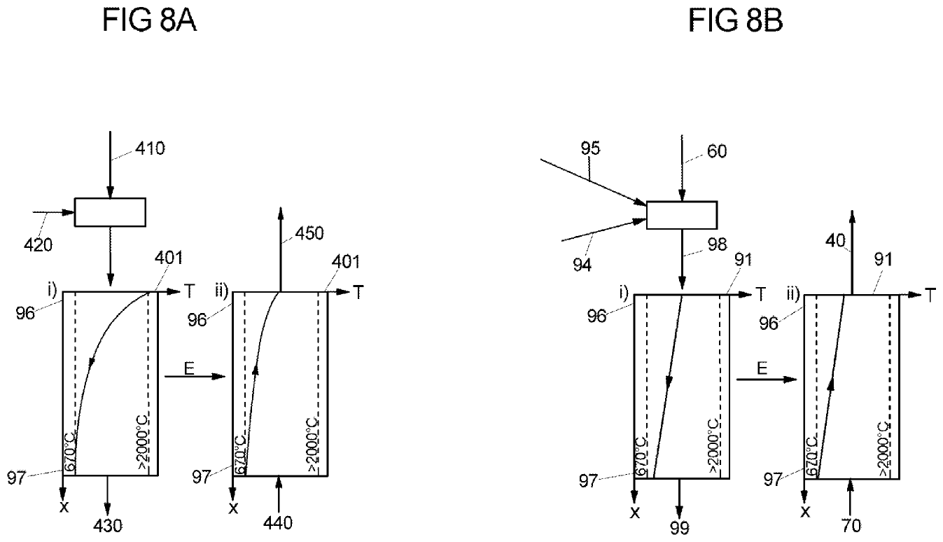

FIG. 8 (A) shows the temperature progression in a regenerator system on charging and discharging which is operated by a process from the prior art; (B) shows the temperature progression in a regenerator system on charging and discharging which is operated by the process according to the invention;

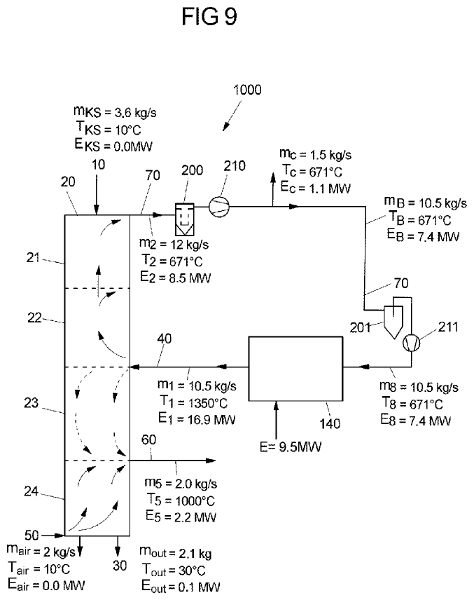

FIG. 9 shows a comparative example according to the prior art;

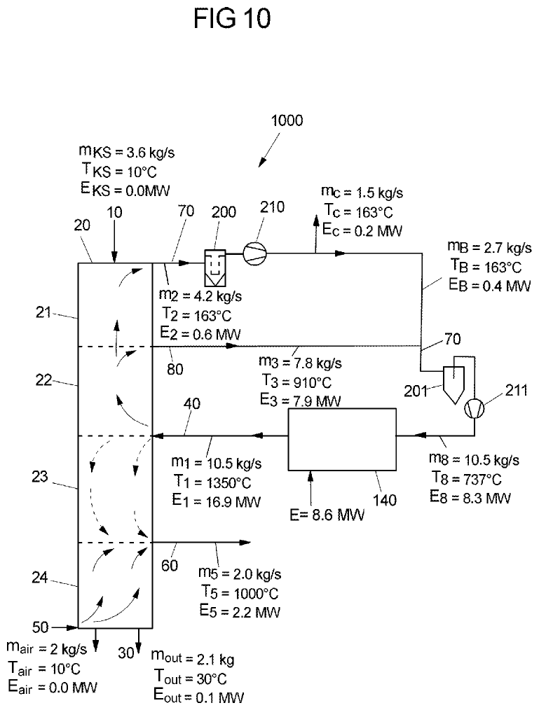

FIG. 10 shows a working example 1 of the present invention;

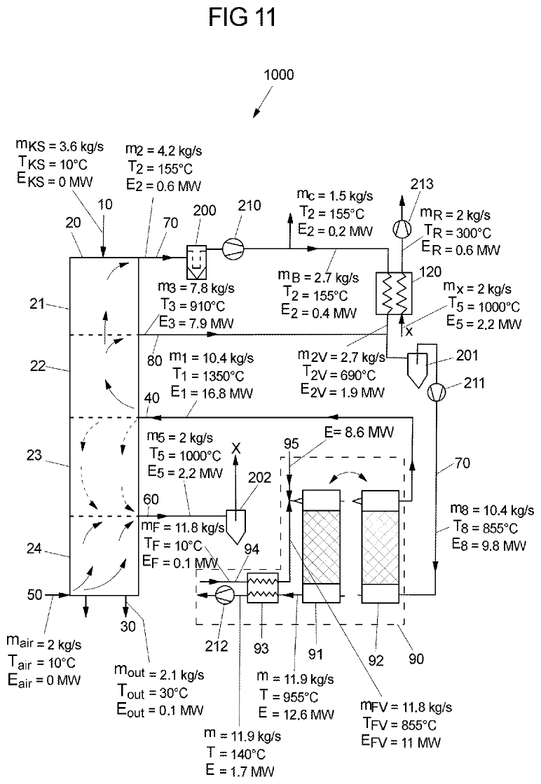

FIG. 11 shows a working example 2 of the present invention.

FIG. 1 shows a shaft furnace 280 for burning of lime from the prior art. In the shaft furnace 280, lime is added via the feed 290. The shaft furnace 280 has a preheating zone 300, a reaction zone 310 and a cooling zone 320. Between cooling zone 320 and reaction zone 310, air and fuel are introduced into the shaft furnace 280 via a fuel and air feed 250. The combustion reaction in the shaft furnace 280 generates sufficient energy to deacidify the lime. At the bottom end of the cooling zone 320, cooling air is introduced via the feed 260 in order to cool the burnt lime before the lime discharge 270. These processes from the prior art do not offer any technical means of generating highly concentrated CO₂ within the process that can be sent directly to further utilization and/or compressed and stored in suitable deposits. Alternatively, it is possible to use solely downstream CO₂ separation methods that entail considerable energy expenditure and financial investment.

FIG. 2 shows one embodiment of the present invention. The shaft furnace 20 has a preheating zone 21, a reaction zone 22, a separation zone 23 and a cooling zone 24. The limestone is introduced into the shaft furnace at the start of the preheating zone via the limestone feed 10. The lime is at a temperature T_{KS} and is introduced into the shaft furnace 20 at a mass flow rate mics. CO₂ at temperature T₁ with a mass flow rate m₁ is introduced into the shaft furnace 20 via the first feed apparatus 40 at the boundary of the separation zone 23 to the reaction zone 22. The temperature T 1 and mass flow rate m₁ of the CO₂ are chosen such that sufficient energy is introduced into the shaft furnace 20 to deacidify the limestone in the reaction zone 22. Above the reaction zone 22, a portion A of the CO₂ is removed from the shaft furnace 20 via the third removal apparatus 80 at a temperature T 3 and a mass flow rate m₃. At the start of the preheating zone 21, at the top of the shaft furnace 20, the remaining CO₂ is drawn off from the shaft furnace 20 via the second removal apparatus 70. The remaining CO₂ is at a temperature T₂ and is drawn off at a mass flow rate m₂. The removal apparatus 70 has a filter 200 for dedusting of CO₂ and a fan 210 for conducting the CO₂ onward in the removal apparatus. A portion m_{C} of the CO₂ is removed from the process. This portion can be provided for further utilization in other processes and/or compressed and stored in suitable deposits.

A portion m_{B} of the CO₂ in the second removal apparatus 70 is passed onward. The third removal apparatus 80 opens into the second removal apparatus 70, and the CO₂ gas streams passed onward in the two removal apparatuses are mixed with one another. The CO₂ which is subsequently passed onward in the second removal apparatus 70 then has a temperature T₈ and a mass flow rate m₈. Before the CO₂ is directed into the heating apparatus 140 at temperature T₈, it is dedusted again in a hot gas filter or hot gas cyclone 201 and passes through a hot gas fan 211. The CO₂ is heated to a temperature T_{W} in the heating apparatus 140. According to the invention, the heating apparatus may be a regenerator system 90, an electrical heating system 100 or a combination of these. After leaving the heating apparatus, the CO₂ arrives back in the shaft furnace 20 via the first feed apparatus. In this embodiment, the temperature T_{W} corresponds to the temperature T₁. A portion of the CO₂ thus flows in a circuit and introduces the energy required for the deacidification reaction inter alia into the shaft furnace 20.

There is therefore a virtually pure CO₂ atmosphere in the shaft furnace 20 within the preheating zone 21 and the reaction zone 22. At the end of the cooling zone 24, cooling air is introduced into the shaft furnace 20 at a mass flow rate mₐᵢᵣ via the second feed device 50. The cooling air is at a temperature Tₐᵢᵣ and cools the burnt lime in the cooling zone 24. At the boundary of the cooling zone 24 to separation zone 23, the cooling air heated to temperature T₅ is drawn off again from the shaft furnace 20 at a mass flow rate m₅. Since the separation zone 23 is between the cooling zone 24 and the reaction zone 22, a separation of the CO₂ atmosphere in the preheating zone 21 and reaction zone 22 from the air atmosphere in the cooling zone 24 is enabled. The cooling air removed at temperature T₅ can be utilized further within the process in accordance with the invention in the apparatus or in the process, or else not be utilized further within the process.

The burnt lime is discharged from the shaft furnace by an apparatus for discharge 30 with temperature Tₒᵤₜ and mass flow rate mₒᵤₜ.

The inventive apparatus 1000 thus makes it possible to use CO₂ as an energy carrier in order to introduce the energy demand for the deacidification reaction into the shaft, where the CO₂ is circulated, or excess CO₂ is sent to a further use and/or compressed and stored intermediately in suitable deposits. Furthermore, no combustion reaction takes place within the shaft furnace 20, which means that no fuels or ashes thereof are introduced into the shaft furnace 20.

The removal of portion A of the CO₂ via the third removal apparatus 80 reduces the exit temperature T₂ of the remaining CO₂ on removal from the furnace via the second removal apparatus 70. Because of the reduced temperature at the top of the furnace, the loss of energy that occurs as a result of the removal of the CO₂ stream m_{C} from the overall process is significantly reduced compared to prior art processes. The heat capacity flow ratio of CO₂ to limestone in the present invention is advantageously in the range from 1 to 2.0, preferably in the range from 1 to 1.6, more preferably in the range from 1 to 1.2. The CO₂ filters and fans in the second removal apparatus 70 may also advantageously be designed for correspondingly lower temperatures.

FIG. 3 shows a further embodiment of the present invention. The construction is the same as is described in FIG. 2. The heating apparatus 140 in this embodiment is a regenerator system 90. The regenerator system 90 has two regenerators 91, 92 that can be charged and discharged in alternation. The CO₂ flows through the second removal apparatus 70 with mass flow rate m₈ and temperature T₈ at the bottom of the charged regenerator, where it is heated to temperature T_{W}, and it is fed back to the shaft furnace 20 from the top of the regenerator via the first feed apparatus 40. In this embodiment, temperature T_{W} corresponds to temperature T₁ with which the CO₂ is introduced into the shaft furnace 20. The regenerators 91, 92 of the regenerator system 90 are charged with a combustion gas. The regenerator system 90 also has a first preheater 93. A feed of fresh air 94 directs fresh air at temperature T_{F} into the preheater with a mass flow rate m_{F}, where it is heated to temperature T_{FV}. In this embodiment, the cooling air removed from the shaft furnace 20 at the boundary of the cooling zone 24 to the separation zone 23 via the first removal apparatus 60 is mixed with the heated fresh air at temperature T_{FV}, and the mixed gas serves as combustion air for the combustion. Before the fresh air is mixed with the cooling air, the cooling air at temperature T₅ is dedusted beforehand in a suitable hot gas filter or hot gas cyclone 202 in order to keep the introduction of dust into the regenerator system 90 as small as possible.

The combustion gas is created by feeding in a fuel via a feed of fuel 95. The combustion air used here is the heated fresh air and the heated cooling air. The combustion gas at a temperature T₇ which is generated in the combustion of the fuel is directed through the regenerators 91, 92, in order to charge these. The combustion gas is introduced at the top of the regenerator, heats it to a temperature T_{RK}, and is led off again at the bottom of the regenerator. This heats the bottom of the regenerator to a temperature T_{RF}. The combustion gas led off at the bottom of the regenerator is advantageously directed through the first preheater 93, which means that the residual heat in the combustion gas can be utilized for heating of the fresh air. In order to remove the cooling air from the shaft furnace, to suck in the fresh air and then to direct the combustion gas through the regenerator, it is possible to use a fan 212.

FIG. 4 shows a further embodiment of the present invention, wherein the construction is similar in principle to that in FIG. 2. This embodiment has a connection via a shortcut conduit 71 from the second removal apparatus 70 to the first feed apparatus 40. The shortcut conduit allows a portion D of the CO₂ removed by suction via the second removal apparatus 70 at the top of the furnace with a temperature T₂ and a mass flow rate m_{D} to be introduced into the first feed apparatus 40. This makes it possible to control the temperature T₁ of the CO₂ which is introduced into the shaft furnace 20. The introduction of the CO₂ with temperature T₂ via the mixing conduit 71 allows fluctuations in the temperature T_{W} with which the CO₂ comes from the heating apparatus 140 to be balanced out. The mixing conduit 71 may have a fan 214.

If the heating apparatus 140 comprises a regenerator system 90, particularly the discharge operation of the regenerator 91, 92 in the regenerator system 90 can lead to periodic fluctuations in the temperature T_{W} with which the CO₂ exits from the regenerator 91, 92. Without further control, temperature T_{W} will correspond to the temperature T₁ with which the CO₂ is introduced into the shaft furnace 20. In that case, the shaft furnace 20 will then be charged with CO₂ having a periodically fluctuating temperature. This also means an energy input into the shaft furnace 20 that fluctuates over time. These fluctuations will affect the temperatures in the shaft furnace, which will correspondingly likewise be subject to fluctuations. Fluctuating temperatures in the shaft furnace are a barrier to uniform lime quality. The apparatus according to the invention and the process according to the invention can avoid the fluctuations in energy input and hence in combustion temperature. In particular, the controlling of temperature T₁ via the supply of CO₂ at temperature T₂ via the shortcut conduit 71 to the CO₂ at temperature T_{W} from the heating apparatus enables the desired control of temperature. Depending on the mixing ratio of CO₂ at temperature T_{W} and CO₂ at temperature T₂, the temperature T₁ can be adjusted and hence controlled.

In addition, FIG. 4 shows an apparatus 1000 in which a portion X of the cooling air removed via the first removal apparatus 60 is directed into the second preheater 120. The heated cooling air is removed from the shaft furnace with temperature T₅ and mass flow rate m₅. The cooling air is dedusted by means of a suitable hot gas filter or hot gas cyclone 202. A portion X is fed to the second preheater 120 and hence utilized to heat the mass flow m_{B} to a temperature T_{2V}. The cooling air is led off downstream of the second preheater. For this purpose, it is possible to use suitable fans 213. The portion X of the cooling air may be all the cooling air removed from the shaft furnace 20 or else only a portion thereof. If the heating apparatus 140 comprises a regenerator system, it is possible to direct a portion Y of the cooling air removed into the regenerator system 90, where it can be used as combustion gas as already described. The proportions X and Y may if required be divided between 0% and 100%, where X+Y=100%.

FIG. 5 shows a further embodiment of the present invention, wherein the construction is similar in principle to that in FIG. 4. The heating apparatus 140 used is an electrical heating system 100. The CO₂ is directed into the electrical heating system via the second removal apparatus 70, where it is heated to temperature T_{W}. It is directed from the electrical heating system via the first feed apparatus 40 into the shaft furnace 20.

FIG. 6 shows an embodiment of the present invention that has all the features of the invention already described. The heating apparatus 140 in this embodiment is designed as a combination of a regenerator system 90 with an electrical heating system 100. The apparatus 1000 has both a shortcut conduit 71 and a second preheater 120. The cooling air drawn off via the first removal apparatus 60 is partly directed into the second preheater 120 and partly into the regenerator system 90.

FIG. 7(A) shows a regenerator system 400 which is operated by a process from the prior art. For charging, combustion gas flows through the regenerator 401. For combustion, lean gas is directed through the preheater 420 via the feed 420 and heated. The heated lean gas is utilized as fuel. The combustion air fed in is cooling air 410 which is removed from the shaft furnace. The combustion gas formed in the combustion is directed into the regenerator 401, which results in charging thereof. The residual heat in the offgas flowing out at the bottom of the regenerator is directed through the preheater 403 and hence utilized for heating of the lean gas. The lean gas used is, for example, blast furnace gas or steel gas. These regenerator systems 400 are used according to the prior art in the steel industry, where the gases mentioned are available.

FIG. 7 (B), with respect to FIG. 7 (A), once again shows a regenerator system 90 which is operated by the present process. This regenerator system 90 enables the flexible utilization of fossil or renewable fuels. In particular, the regenerator system 90 can advantageously be used in the lime industry, in which lean gases, for example blast furnace gas, are unavailable. High-energy fuels are used in the lime industry, for example natural gas. However, these cannot be used in regenerator systems 400 from the prior art, since the high-energy fuels cannot be heated in a preheater. The regenerator system 90 according to the present invention remedies this disadvantage and hence enables uncomplicated use of the invention in the lime industry. A detailed description of the mode of function of the regenerator system 90 can be found in the description of FIG. 3.

FIG. 7 (C) shows a regenerator 91 of the regenerator system 90. At the top of the regenerator 96, the combustion gas is introduced 98 and flows through the regenerator 91 on charging, and leaves it again at the bottom of the regenerator 97 via the outlet 99. The regenerator 91 is heated to temperature T_{RK} at the top of the regenerator 96, and to temperature T_{RF} at the bottom of the regenerator 97.

On discharge, the CO₂ flows into the regenerator via the second removal apparatus 70 at temperature T₈ at the bottom of the regenerator 97, flows through it and leaves the regenerator 91 at the top of the regenerator 96 with temperature T_{W} via the first feed apparatus 40.

FIG. 8 (A) shows the temperature progression in a regenerator system 400 from the prior art, as shown in FIG. 7 (A), on charging and discharging. In the diagram i), the regenerator 401 is charged by the feeding 410 of a combustion gas. The combustion gas forms as a result of the combustion of cooling air (feed via cooling air feed 410) which is removed from a shaft furnace with a fuel (feed via fuel feed 420). The mass flow of the combustion gas is therefore determined to a crucial degree by the mass flow of the cooling air. The combustion gas is typically at a high temperature above 2000° C. At the top of the regenerator 96, the storage medium of the regenerator 401 is therefore charged to a temperature above 2000° C. Over the entire length x of the regenerator, the combustion gas releases thermal energy to the storage medium, and leaves the regenerator 401 at the bottom of regenerator 97 typically at a temperature of about 700° C. The diagram ii) shows the discharging of the regenerator 401. CO₂ is typically introduced into the bottom of the regenerator 97 at a temperature of about 700° C. via the CO₂ feed 440 and directed through the entire length x of the regenerator. At the top of the regenerator 96, the CO₂ leaves the regenerator 401 via the outlet 450 at a temperature T₁. At the changeover from charging to discharging, the top of the regenerator 96 is therefore supplied firstly with combustion gases at a temperature of above 2000° C. and, straight after the changeover to discharging, with CO₂ at a temperature T₁. The heat capacity flow ratio between combustion gas that flows through the regenerator system on charging and CO₂ that flows through the regenerator system on discharging is well above 1.5, typically in the range from 2 to 2.5 (Yang et al.). At the top of the regenerator 96, the temperature level fluctuates significantly, such that great thermal stresses arise in the storage material. This leads to the numerous disadvantages already described.

FIG. 8 (B), by contrast, shows the temperature progression in a regenerator system 90 according to the present invention, as shown in FIG. 7 (B), on charging and discharging. In the diagram i), the regenerator 9 is charged by the supply of a combustion gas 98. The combustion gas forms as a result of the combustion of fresh air (supply via fresh air feed 94) and optionally cooling air (supply via first removal apparatus 60), which is drawn off from the shaft furnace, with a fuel (supply via fuel feed 95). The mass flow rate of the combustion gas is determined to a crucial degree by the mass flow rate of the fresh air and is therefore flexibly adjustable. This makes it possible to adjust the heat capacity flow ratio between combustion gas that flows through the regenerator system on charging and CO₂ that flows through the regenerator system on discharging in such a way that it is in the range from 0.9 to 1.1. At the top of the regenerator 96, a significantly smaller thermal stress thus acts on the regenerator material. This has a positive effect on the service life of the storage material of the regenerator and hence on the maintenance intensity thereof. The economic viability of the overall process is thus significantly increased.

The combustion gas may, for example, have a temperature of about 1450° C. At the top of the regenerator 96, the storage medium in the regenerator 91 is therefore charged to a temperature of about 1450° C. Over the entire length x of the regenerator, the combustion gas releases thermal energy to the storage medium, and at the bottom of the regenerator 97 leaves the regenerator 401 typically at a temperature of about 800° C. Diagram ii) shows the discharging of the regenerator 91. CO₂ is typically introduced into the bottom of the regenerator 97 at a temperature of about 700° C. via the second removal apparatus 70 and directed through the entire length x of the regenerator. At the top of the regenerator 96, the CO₂ leaves the regenerator 91 via the first feed apparatus 40 at a temperature of, for example, 1350° C. At the changeover from charging to discharging, the top of the regenerator 96 is therefore supplied firstly with combustion gases at a temperature of about 1450° C. and, straight after the changeover to discharging, with CO₂ at a temperature of about 1350° C. The difference in temperature at the top of the regenerator 96 is thus significantly reduced, which means that the thermal stresses that occur are also significantly decreased.

FIGS. 9 to 11 show a comparative example according to the prior art and two working examples of the invention. For these examples, it was assumed that complete physical separation of the gas atmospheres (CO₂ in the reaction zone and cooling air in the cooling zone) is assured. All process parameters such as temperatures and mass flow rates are specified in examples. In addition, the energy flows that are introduced or removed are specified. These were identified in each case by the symbol E and the addition already used for the corresponding temperature and the corresponding mass flow rate. All energy flows reported in the examples are based on a reference temperature of 0° C.

### Comparative Example 1

FIG. 9 shows a process example according to the prior art. All the CO₂ which is fed to the shaft furnace 20 via the feed apparatus 40 and exits from the limestone during the deacidification flows in the direction of the top of the furnace and is removed via the removal apparatus 70. The heating apparatus 140 is supplied with the flow of energy required for the process. For comparability, it was assumed by way of simplification that this flow of energy can be utilized entirely for heating of the CO₂ (mass flow rate m₈), and that no heat losses occur, for example, as a result of a combustion process. The heating apparatus here is otherwise unspecified. The heated cooling air which is removed from the shaft furnace 20 via the removal apparatus 60 is not utilized further within the process.

### Working Example 1

FIG. 10 shows an embodiment of the present invention that increases the energy efficiency of the process example shown in FIG. 9 according to the prior art. Proceeding from the process example in FIG. 9, according to the invention, the third removal apparatus 80 is used for this purpose, by means of which a portion of the CO₂ flowing upward within the shaft furnace 20 is removed and then mixed with the remaining CO₂ from the top of the furnace, heated, and supplied again to the shaft furnace 20 via the feed apparatus 40. Thus, not all the CO₂ flows in the direction of the top of the furnace, and the mass flow rate m₂ and temperature T₂ are lowered by comparison. As a result, the CO₂ flow rate m_{C} leaves the process at a lower temperature, which reduces the loss of heat by comparison. This likewise becomes clear by virtue of the lower energy demand for heating of the circulating CO₂ (mass flow rate m₈) through the heating apparatus 140.

### Working Example 2

FIG. 11 shows an embodiment of the present invention having all the features of the invention that have already been described. The process according to the invention was conducted by the embodiment of the invention shown. All the cooling air sucked out by the first removal apparatus 60 was fed here to the second preheater 120. The heating apparatus used was a regenerator system 90. The combustion gas for the loading of the regenerator system 90 was created by the supply of natural gas L as fuel and heated fresh air at temperature T_{FV}.

### LITERATURE

[Maerz Ofenbau A G] Maerz Ofenbau A G, Sustainable lime burning technology with shaft kilns, ZKG 6/2021
[Yang et al.] Yang et al., Novel Lime Calcination Systems for CO₂ Capture and its Thermal-Mass Balance Analysis, ACS Omega, 5 (42), 27413-27424, 2020
[Schiele/Berens] E. Schiele/L. W. Berens, “Kalk” [Lime], Verlag Stahleisen M. B. H. Dusseldorf, 1972, page 190, section 4.3.4.4

### LIST OF REFERENCE NUMERALS

10 limestone input
20 shaft furnace
21 preheating zone
22 reaction zone
23 separation zone
24 cooling zone
30 apparatus for discharging burnt lime
40 first feed apparatus
50 second feed apparatus
60 first removal apparatus
70 second removal apparatus
71 shortcut conduit
80 third removal apparatus
90 regenerator system
91, 92 regenerator
93 first preheater
94 feed for fresh air
95 feed for fuel
96 top of regenerator
97 bottom of regenerator
98 combustion gas feed
99 offgas outlet
100 electrical heating system
120 second preheater
140 heating apparatus
200 filter
201 filter
202 filter
210 fan
211 fan
212 fan
213 fan
214 fan
250 fuel supply and air supply
260 cooling air supply
270 lime discharge
280 shaft furnace
290 limestone feed
300 preheating zone
310 reaction zone
320 cooling zone
400 regenerator system
401 regenerator
402 regenerator
403 preheater
410 cooling air feed
420 fuel feed
430 offgas outlet
440 CO₂ feed
450 CO₂ outlet
1000 apparatus

1. Apparatus for production of burnt lime or dolomite, having:
a shaft furnace having a preheating zone, a reaction zone, a separation zone and a cooling zone;
a first feed apparatus for CO₂ at a boundary of the separation zone to the reaction zone;
a first removal apparatus at a boundary of the cooling zone to the separation zone;
a second removal apparatus for CO₂ at a start of the preheating zone; and
at least one heating apparatus;
wherein
the shaft furnace also has a third removal apparatus for CO₂ above the reaction zone;
the third removal apparatus outside the shaft furnace opens into the second removal apparatus upstream of the at least one heating apparatus;
the second removal apparatus opens into the at least one heating apparatus; and
the first feed apparatus is formed by the at least one heating apparatus for the shaft furnace.

2. Apparatus according to claim 1, wherein the at least one heating apparatus is a regenerator system, an electrical heating system or a combination thereof.

3. Apparatus according to claim 1, wherein the at least one heating apparatus has a regenerator system, and the latter has at least two regenerators, a first preheater, a feed for fresh air, and a feed for a fuel.

4. Apparatus according to claim 3, wherein the first removal apparatus is connected to the regenerator system.

5. Apparatus according to claim 1, wherein the apparatus has exactly one heating apparatus.

6. Apparatus according to claim 1, wherein there is no heat exchanger in the third removal apparatus.

7. Apparatus according to claim 1, wherein the first removal apparatus is in contact with the second removal apparatus in a form of a second preheater.

8. Apparatus according to claim 1, wherein the second removal apparatus is connected directly to the first feed apparatus via a shortcut conduit upstream of a point at which the third removal apparatus opens into it.

9. Process for producing burnt lime or dolomite in an apparatus having:
a shaft furnace having a preheating zone, a reaction zone, a separation zone and a cooling zone;
a first feed apparatus for CO₂ at a boundary of the separation zone to the reaction zone;
a first removal apparatus at a boundary of the cooling zone to the separation zone;
a second removal apparatus for CO₂ at a start of the preheating zone;
at least one heating apparatus; and
a third removal apparatus for CO₂ above the reaction zone; wherein
the third removal apparatus opens into the second removal apparatus outside the shaft furnace and upstream of the at least one heating apparatus;
the second removal apparatus opens into the at least one heating apparatus; and
the first feed apparatus is formed by the at least one heating apparatus for the shaft furnace;
wherein
a) limestone or dolomite rock is introduced into the preheating zone of the shaft furnace;
b) preheated CO₂ at a temperature T₁ and with a mass flow rate m₁ is introduced into the shaft furnace via the first feed apparatus between separation zone and reaction zone;
c) a portion A of the CO₂ with mass flow rate m₃ and temperature T₃ is removed from the shaft furnace via the third removal apparatus above the reaction zone;
d) remaining CO₂ with temperature T₂ is removed from the shaft furnace via the second removal apparatus at the start of the preheating zone, a portion B of the CO₂ removed is passed onward with mass flow rate m_{B}, and a portion C is sent to other uses or suitable deposits with mass flow rate mc;
e) portion A of the CO₂ is combined with portion B of the CO₂ to give a mixed gas with temperature T₈, and the mixed gas with temperature T₈ is heated to temperature T_{W} in the at least one heating apparatus, and the CO₂ with temperature T_{W} forms at least a portion of the preheated CO₂ which is fed to the shaft furnace in process step b) via the first feed apparatus;
f) the burnt lime or dolomite is cooled in the cooling zone by cooling air supplied, and the cooling air with temperature T₈ and mass flow rate m₅ is removed again from the shaft furnace via the first removal apparatus between the cooling zone and the separation zone; and
g) the cooled burnt lime or dolomite is discharged from the shaft furnace with temperature Tₒᵤₜ and mass flow rate mₒᵤₜ.

10. Process according to claim 9, wherein the process further comprises:
h) a portion D of the CO₂ removed in process step d) is fed into the CO₂ preheated to temperature T_{W} via a shortcut conduit before it is introduced into the shaft furnace.

11. Process according to claim 9, wherein, prior to process step e), portion B of the CO₂ removed in process step d) is heated to temperature T_{2V} in a preheater by a portion of the cooling air removed in process step f).

12. Process according to claim 9, wherein, in process step e), the at least one heating apparatus comprises at least one regenerator, a preheater, a fresh air feed and a fuel feed, and
fresh air is heated to a temperature T_{FV} in the preheater;
the fresh air heated to temperature T_{FV} for combustion with a fuel selected from carbonaceous fuels and/or hydrogen; and
combustion gases formed in the combustion are guided through the at least one regenerator at a temperature T₇ and heat the at least one regenerator to temperature T_{RK} at a top of the at least one regenerator and T_{RF} at a bottom of the at least one regenerator.

13. Process according to claim 12, wherein the fresh air heated to temperature T_{FV} in the preheater is additionally supplied with a portion of the cooling air removed in process step f), and the mixed gas serves for combustion with the fuel selected from carbonaceous fuels and/or hydrogen; and
the combustion gases formed in the combustion are directed through the at least one regenerator at the temperature T₇ and heat the at least one regenerator to temperature T_{RK} at the top of the at least one regenerator and T_{RF} at the bottom of the at least one regenerator.

14. Process according to claim 9, wherein a combustion temperature in the shaft furnace is controlled by controlling the temperature T₁ while the mass flow rate m₁ is constant, or by controlling the mass flow rate m₁ while the temperature T₁ is constant.

15. Process according to claim 9, wherein reactivity of the burnt lime or dolomite is controlled by controlling the mass flow rate mₒᵤₜ.
